(19) United States
(12) Patent Application Publication
(10) Pub. No.: US 2017/0286898 A1
(43) Pub. Date: Oct. 5, 2017

(54) METHOD AND SYSTEM TO ALERT INVENTORY CHANGES ON RETAIL DISPLAYS

(71) Applicant: Joseph Marsh Ryan, III, Longmont, CO (US)

(72) Inventor: Joseph Marsh Ryan, III, Longmont, CO (US)

(21) Appl. No.: 15/087,591

(22) Filed: Mar. 31, 2016

(51) Int. Cl. G06Q 10/08; G06Q 30/06

(52) U.S. Cl. CPC G06Q 10/087; G06Q 30/0639

(57) ABSTRACT

The present invention is a system and method for determining product movement using a sensor. Through the interaction of items placed on an array of sensors connected to a circuit board controller, the apparatus is configured to detect a change in capacitance caused by the interaction and thereby associate it with an item or groups of items. Detection and association of such signals recorded in a database with items displaced in a storage location permits a user to keep track of said items remotely through a computing device.

### CROSS REFERENCE TO RELATED APPLICATION

This application claims the benefit of the following provisional application which is hereby incorporated by reference in its entirety: U.S. Provisional Patent Application No. 62/141,744 filed on Apr. 1, 2015 and entitled “A METHOD AND SYSTEM TO ALERT INVENTORY CHANGES ON RETAIL DISPLAYS.”

### FIELD OF THE INVENTION

The present invention generally relates to the field of inventory tracking and control. Specifically, embodiments of the present invention are directed towards an arrangement of sensors on a peg hook or display rack that detects when an item is removed from the display rack.

### BACKGROUND

Inventory monitoring and control are perennial concerns in retail, manufacturing, shipping, and various other settings. Operating businesses in these fields often entails the placement and removal of items on display fixtures. In the retail sphere, among others, it is in many cases preferable to replenish the stock of certain items as soon as possible after their removal from their location of storage, display, or sale. In almost every instance, it is also desirable to be able to identify product loss, destruction or theft at the time of their occurrence or as close to it as possible.

In order to monitor the amount of and keep track of the placement of various items, conventional product inventory and security systems employ technology such as barcode scanners, radio frequency identification (RFID), electronic article surveillance (EAS), shelf weight scales, and closed circuit television networks. However, due to the inherent drawbacks of such systems, even when properly implemented, theft or loss of product is often not detected until long after the occurrence thereof, usually with such theft or loss not being registered until or even after the attempted extraction of the products from the premises. Furthermore, accurate monitoring of the stock or supply of products continues to demand physical inspection and perusal, as inventory levels or placement of items in storage, sale, or display areas continue to be inspected and verified by employees. This state of affairs allows for considerable product and revenue loss due to pilferage and inadequate product stocking to meet demand or customer interest.

For the foregoing reasons, there is a need for a system and method that can automatically track the location, presence, and/or absence of items in an inventory and electronically relay that information for convenient consumption by the user or operator of the system.

### SUMMARY

The present invention is directed to an apparatus and method that satisfy the need for an automatic system for product movement and inventory tracking. The apparatus having features of the present invention comprises one or more electronic sensors configured to detect changes in electronic signatures caused by the interaction of an item being placed on a display fixture and display fixture that it rests on. The invention further comprises a microcontroller that controls the operation of the apparatus, a proximity sensor and a power source. In some embodiments, the invention may comprise additional or alternate components that will become understood by one of skill in the art as suitable for implementing the system taught herein, in each case without departing from the spirit or scope of the invention.

Various arrangements of sensor fixtures are contemplated by the several embodiments of the present invention as they may be individually deployed, connected with one another in a linear fashion, or deployed as part of an interconnected array of such sensors. In a preferred embodiment, the sensors relay signals to the microcontroller circuit board, which is configured to detect and record the unique changes in state of the aforementioned change in proximity. Thereafter, the information is relayed to be stored in a database from which it can subsequently be retrieved.

The advantages of the present invention are that it provides immediate notification regarding the placement or removal of items thereon and allows for instantaneous feedback. In a preferred embodiment, the invention enables a user or operator of the invention to be much more quickly notified of the depletion of the stock of a product or of an unauthorized removal of an item placed on the sensor arrangement with a high degree of accuracy and reliability and without the need for repetitive physical verification by a person.

According to an embodiment of the present invention, the inventory tracking apparatus comprises an electronic proximity sensor, wherein the sensors and are configured to detect movement of an item via a change in sensor caused by the interaction between the sensor, the display fixture, and the item; a controller communicatively connected to one or more sensors; and a database that receives data from the controller and is configured to generate a signal based in part on the change in the sensor.

According to an embodiment of the present invention, the sensors are substantially three dimensional. In another embodiment of the present invention, the sensors comprise a network of sensors arranged on a multiplicity of display hooks. In another embodiment of the present invention, the fixture holding the sensor is a discrete component within each of the sensors. In another embodiment, the sensors comprise a printed circuit.

According to an embodiment of the present invention, the method of inventory tracking comprises the steps of detecting a proximity signal change when an item is placed on a display fixture; generating a signal signature based in part on the proximity change; and tracking a movement of said item based in part on a change in said item location indicated by said signal change.

According to an embodiment of the present invention, the method of inventory tracking comprises the step of associating said signal into a database as an item location for said item. According to another embodiment of the present invention, the method of inventory tracking repeats all of its constituent steps after a predetermined period of time.

According to an embodiment of the present invention, the method of inventory tracking comprises the step of displaying the said movement of said item to a user via a computing device. In another embodiment of the present invention, the method of inventory tracking comprises the steps are performed at least in part by an apparatus that comprises sensors, wherein the sensors are configured to detect movement of an item via a change in infrared signals caused by the interaction between the sensor, and the item; a controller communicatively connected to one or more sensors; and a database that receives data from the controller and is configured to generate a signal based in part on the change in the sensor.

The foregoing summary of the present invention with the preferred examples should not be construed to limit the scope of the invention. It should be understood by one skilled in the art that the examples of the invention thus described may be further modified without departing from the spirit and scope of the invention.

### BRIEF DESCRIPTION OF THE DRAWINGS

These and other features, aspects, and advantages of the present invention will become better understood with reference to the following description and appended claims and accompanying drawings where:

FIG. 1 is schematic diagram of an exemplary embodiment of the present invention illustrating a retail display depicting the location of products, different identifying markers respectively associated with a plurality of different products, and the exterior portions of the elements of the invention embodiment displaced thereon;

FIG. 2 is a schematic diagram of a side view of an exemplary embodiment of the present invention illustrating a display hook with a sensor arranged and connected to a display unit;

FIG. 3 is a schematic diagram depicting a detailed illustration of an exemplary display hook microcontroller and sensor of a preferred embodiment of the present invention including integrated circuits, sensors, resistors, capacitors, shift registers, timing circuits, connectors, traces, and wiring;

FIG. 4 is a schematic diagram depicting an exterior view of the apparatus depicting the location of a sensor and battery compartment;

FIG. 5 is a schematic diagram depicting an exterior view of a smart phone displaying an app;

FIG. 6 is a schematic diagram depicting an exemplary embodiment of an information pattern card of a display pattern and an exemplary embodiment of a display hook card attachment apparatus;

FIG. 7 is a schematic diagram depicting a wireless node;

FIG. 8 is a block diagram illustrating a high-level overview of a preferred embodiment of the present invention;

FIG. 9 is a flowchart showing an exemplary sensor and product association process; and

FIG. 10 is a flowchart showing an exemplary sensor reading process.

FIG. 11 is a block diagram illustrating a high-level overview of a preferred embodiment of the present invention.

### DETAILED DESCRIPTION

In the Summary above, the Detailed Description, the claims below, and in the accompanying drawings, reference is made to particular features (including method steps) of the present invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Whenever a reference herein is made to a method comprising two or more defined steps, the defined steps can be carried out in any order or simultaneously (except where the context excludes that possibility), and the method can include one or more other steps which are carried out before any of the defined steps, between two of the defined steps, or after all of the defined steps (except where context excludes that possibility).

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be operated and implemented by a user of a computing device whether connected to a network or not. According to an embodiment of the present invention, some of the applications of the present invention may not be accessible when not connected to a network, however a user may be able to compose data offline that will be consumed by the system when the user is later connected to a network.

The preferred embodiment of the apparatus to which the present invention is directed primarily comprises one or more of each of a display sensor, a display card, a microcontroller, a wireless node, a display hook, and an externally accessible database. Generally, the system detects product placement or movement by sensing changes in sensor readings near a product. When an item is placed near a sensor, the relative luminescence or reflection of the product or displayed item and display card increases the intensity of the return signal of the sensor. Conversely, when a product is removed from the vicinity of a sensor, the sensor's sensitivity decreases. Accordingly, in order to enable the aforementioned detection, the sensor is preferably made of an infrared, proximity, or photovoltaic sensing apparatus, a power source, a microprocessor and a durable enclosure. As will be further described, the shape and arrangement of the sensors can be varied and depends on the typical arrangement of the items to be sensed. However, a preferred embodiment of the sensor array arrangement comprises a grid of display sensors placed on a display hook near the items to be sensed.

In some embodiments of the invention, the sensor may be a separate element positioned adjacent, above or below to the displayed item. In the preferred embodiment the sensor described above may be created using various techniques that are well known in the art.

Whenever a single sensor or sensor display is discussed herein, to the extent logically possible, any aspects, features, or embodiments thereof should be understood to be equally applicable to a plurality of sensors and sensor displays or any arrangement or array thereof, as applicable. Analogously, wherever a plurality or arrangement of sensors or sensor displays is discussed, the teaching herein should be deemed equally applicable, wherever logically possible, to a single sensor or sensor display.

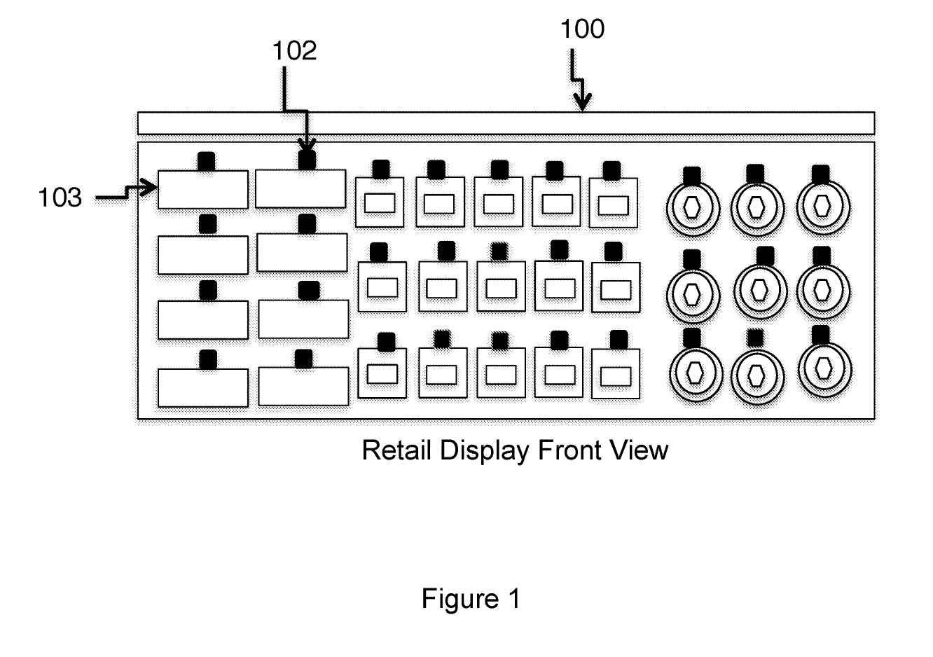

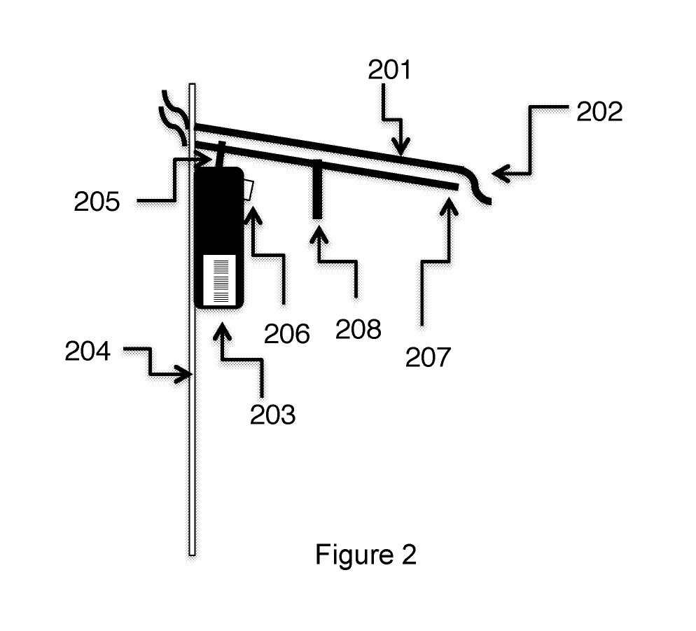

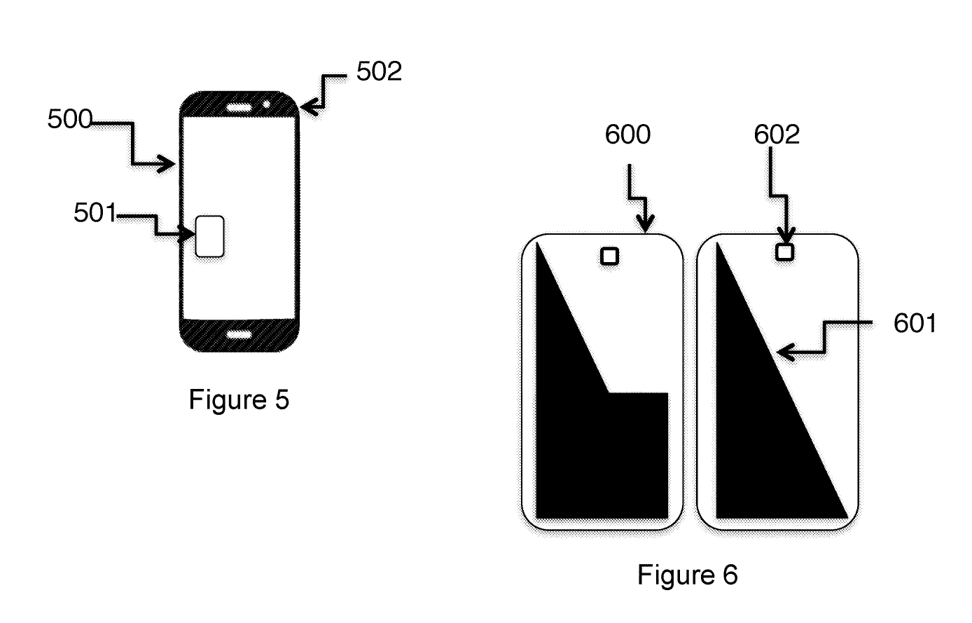

Referring now to the drawings wherein the illustrations are for the purposes of showing one or more exemplary embodiments, FIG. 1 depicts the front view of a retail display comprising a plurality of items 103 arranged on a display unit 100 and a sensor 102 attached to a display hook as depicted in FIG. 2. In the preferred embodiment, the sensor 102 is a continuous extension of and is connected to the display hook sensor housing and display unit 100, which contains the electronic components described below, and protects them from the external environment or unintended interaction from outside of the housing. Although the sensor 102 can be separate from the display unit 100, in a preferred embodiment the entirety of the continuous unit comprised of the sensor 102 and its plurality of sensors on the display units 100. As will be more clearly explained in the description relating to FIG. 2, the display hook 207, in an alternative embodiment, can be placed in any area of the display unit 100. To facilitate the identification of the items 103 placed on the display hook 207, identifying marking such as barcodes FIG. 6 601, can be placed on the display hook 207 behind or adjacent to the items to be placed on the display hook 207. As can further be seen in the center of FIG. 2, a display card 208 containing said barcode or other identifier serves to identify the item 103 and its distance from the sensor 102. Those skilled in the art will appreciate that the sensor 102 can serve as a means for communication between the constituent electronic parts of the system. Accordingly, the sensor 102 can be a singular element of a type that incorporates both communication and power transmission, or be composed of separate wires each serving one of those respective functions and leading either to a power source or at least one other electronic component of the system or self powered by means of a battery and wireless communications.

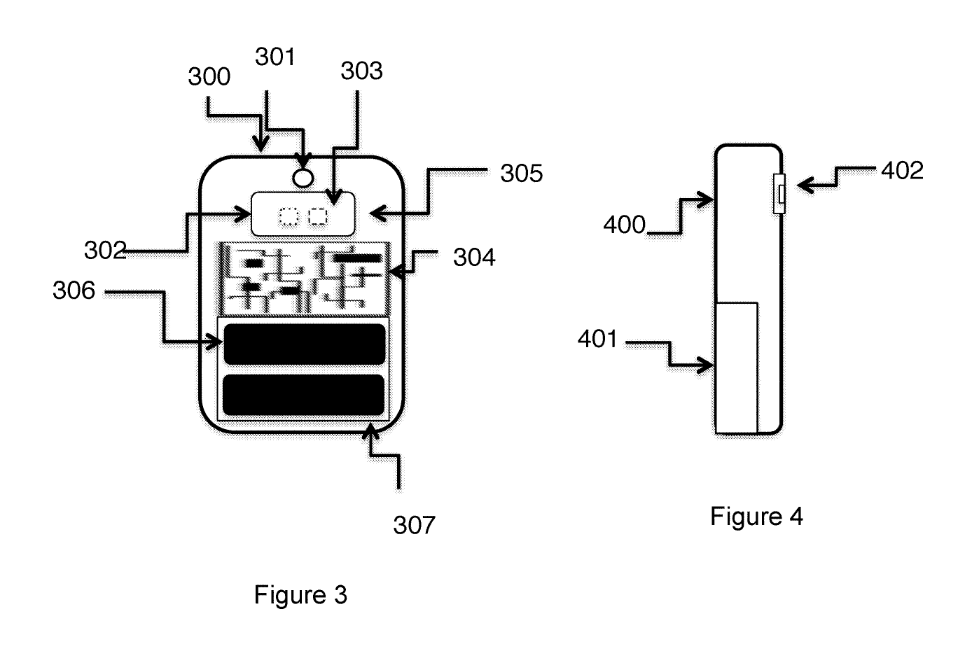

The sensor 102, the interior of which can be better seen in FIG. 3, is preferably made of a plastic material and internally composed of several electronic components and a battery supply. In a preferred embodiment the arrangement of the electronic components comprising the sensor 102 is as follows: (a) a housing made of plastic; (b) a sensor element, (c) a battery compartment, (d) a micro processor; (e) a wireless transmitter; (f) a attachment hole to hold the sensor on the display hook. The size, shape, dimensions, and orientation of the sensor as a whole along with that of the interior sensor portions of the sensor in particular, can all be variable and governed by the shape of the the objects which are to be sensed.

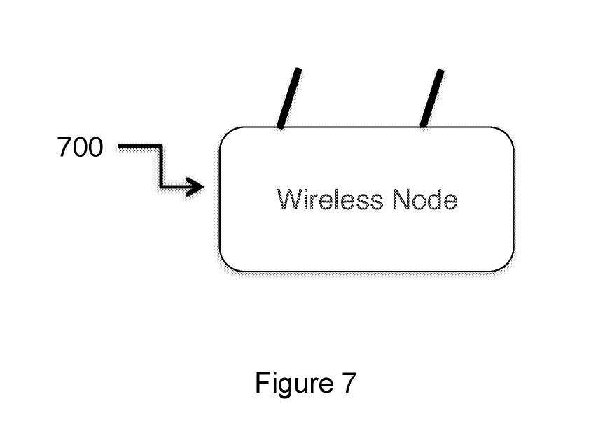

Accordingly, in some embodiments of the present invention, a single sensor 102 can be composed of one or more sensors 302 that may be deployed independently. Additional sensing technologies may also be included such as an accelerometer to improve battery life. One of ordinary skill in the art would appreciate that there are numerous manners in which the system could be configured and embodiments of the present invention are contemplated for use with any configuration. In other embodiments, a plurality of sensors 302 may be arranged in a sequence within a sensor 302 as seen in FIG. 3, or in an array. The exemplary embodiment of a sensor illustrated in FIG. 3 depicts the internal components and connections in a cutaway view which were not visible in FIG. 1. In this embodiment, the sensors 302 are arranged in a horizontal position in alternative embodiment of the invention the sensors can be arranged perpendicular or orthogonal in the sensor housing 300 and to the item to be sensed 103. The micro controller 304 is displaced in sensor housing 300, which is intended to protect the components from environmental affects such as dust, shock or liquids. The display hook hole or attachment apparatus 301 is used to hold the sensor 102 on the display hook 207. The display hook retainer 201 keeps the items 103 from sliding off the display hook 207. The curve on the end of the display hook retainer 202 is adjustable to facilitate the size and the weight of the item, which is placed on the hook. FIG. 7 is a depiction of a wireless communications node 700. Those skilled in the art will appreciate that the wireless node 700 can serve as a means for communication between the constituent electronic parts of the system.

Therefore, the size, shape, dimensions, and orientation of the components described above can be varied and tailored to conform to the available space and the nature of items 103 to be sensed. The sensor 102 can be customized to fit the dimensions of the display hook 207, display unit 100 or item 103 to be sensed is to be placed, and to accommodate the types of items or products which one intends to place upon the display hook 207. In the alternative embodiment mentioned earlier, the display hook components 207, 201, 202, 205, 208 can be adjusted to accommodate various sizes and weights of the items 103 to be place on the display hook apparatus depicted in FIG. 2.

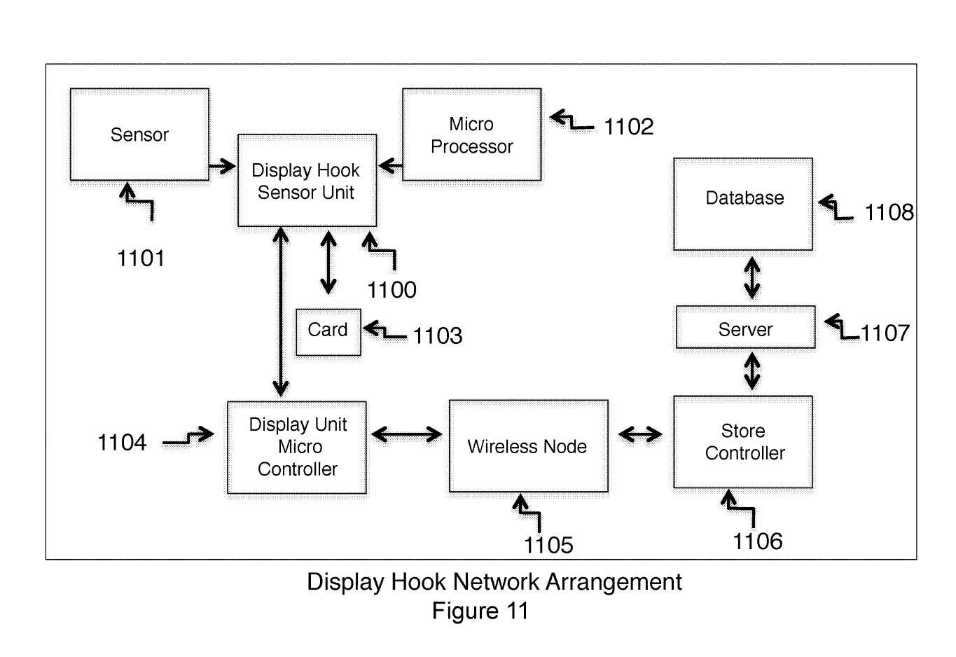

In any embodiment, the sensor or array of sensors depicted in FIG. 1 are electrically or wirelessly connected to a computing device such as the store controller depicted in FIG. 11 lower right hand corner of the drawing and labeled Store Controller 1106 and wireless node 1105. Multiple sensors 102 and wireless nodes 1105 may be connected together via a cable or wireless protocol embodying various communication technologies such as RS-485, Ethernet or any other alternative known in the art suitable for such communication and power transmission. Accordingly, each sensor 102 is electrically connected to the Store Controller 1106 and database via a wired or wireless network as depicted in the flow chart in FIG. 11.

The preferred embodiment of the senor comprises a plurality of sub-components such as integrated circuits, resistors, capacitors, shift registers, timing circuits, traces, and wiring, as seen in FIG. 3, all of which are distributed within a Printed Circuit Board (PCB) substrate. A preferred embodiment of the sensor 102 further comprises a microcontroller 304, and a plurality of traces printed or deposited on the PCB board connecting the various elements displaced thereon. As can be seen in FIG. 11, the input signals from the sensors 102 is transmitted into the wireless node 700 and then on to the store controller where a series of algorithms serve to filter out the relevant and desired item movement and status data. Since the system may comprise any plurality of such sensors and controllers, they may be connected to each other in a daisy chain and further connected to a store controller as represented in the block diagrams of FIG. 11. The store controller serves to aggregate the signals from all of the sensors, manage the wireless network, and transmit the collected data to a network database 1107.

As items are placed, arranged, or moved on the sensor display hook 102 attached to the display unit 100 the sensor 102 or interconnected sensor array generates a particular signal change that an identified item 103 has been placed, arranged, or moved and is detected and registered by the apparatus via the operation of the sensor, wireless node, and store controller described above.

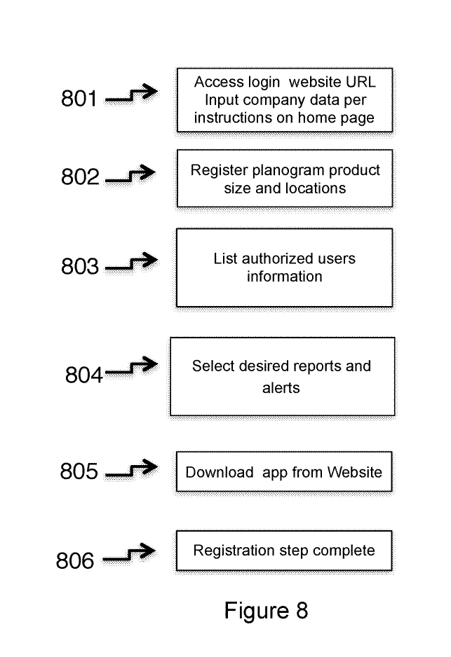

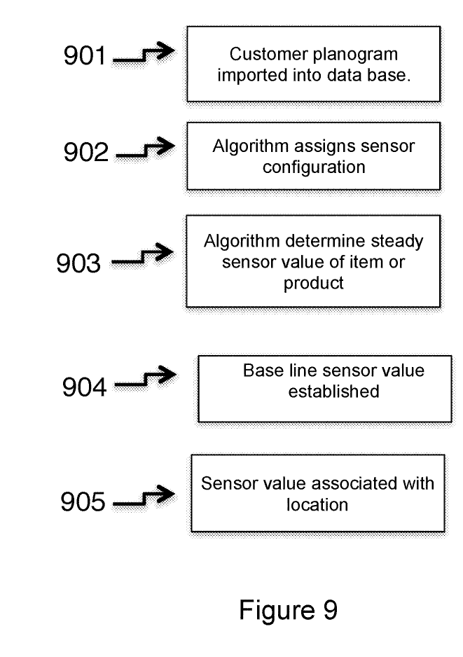

According to a preferred embodiment of the present invention and depicted in FIGS. 8 and 9 , the apparatus may further comprise software and an algorithm within said secure database which is configured to detect the sensor signals and to associate the inventory levels and item movement to particular authorized planograms (diagrammatic representations of product arrangement layouts) as well as to normalized sales and operational activities. This software can be run on a computer or server in the same facility as the sensors or it can be hosted off-site. In either case, a preferred embodiment of the invention has the sensors communicate with the software application through standard computer network technologies such as Ethernet or WiFi. A global overview of the system is depicted in FIG. 11 where a sensor display hook sensor unit 1100, can be seen as connected to a shelf controller 1106, which are linked to a local application server 1107 that is then further connected to a database software application either via the internet or a WAN.

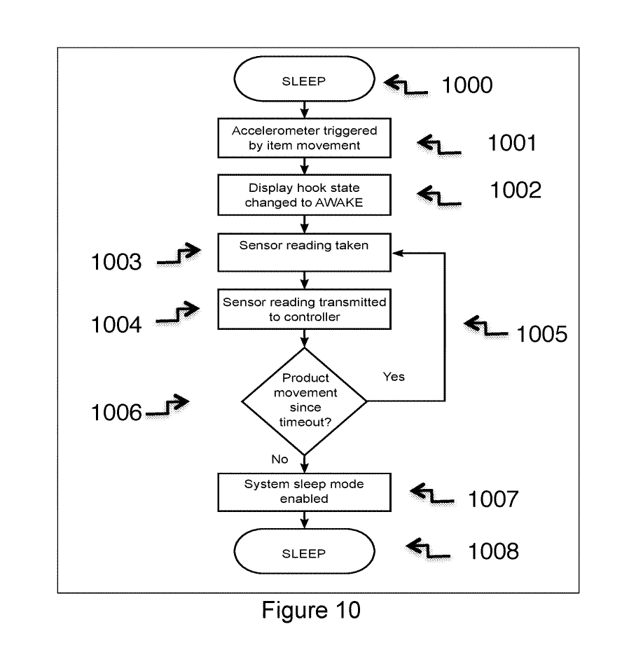

The present invention is further directed to a method for detecting product placement, absence, and movement. As shown by FIG. 9 and FIG. 10, the method primarily comprises steps of registration and signal association as well as the steps involved in the detection of the proximity change signal. Users of the system can interact with the system via a cloud-based hosted database 1108 to which users should first login and register. The step of registration further comprises the steps of accessing a logging website to input data; registering planogram product size and locations; listing the information of the authorized users; selecting reports and desired alerts; altering the sensor signals associated with product detection; altering other parameters of the sensing system including but not limited to that of data upload frequency, alarm thresholds, and alert trigger values; and downloading an application from a website. The signal association step further comprises the steps of importing a customer planogram into a database and assigning a pad configuration via an algorithm that determines which sensors should be associated with which product types by using the dimensions and layout of the products described in the planogram with the known dimensions and layout of the sensors. Alternatively a user may manually associate a product type with specific sensors through a software interface. This manual association may be aided by scanning barcodes on products and position barcodes located on the display. In a preferred embodiment, after products are associated with specific sensors, a calibration sequence is then performed to determine proximity values specific to each product and determine the steady state of the signal associated with each sensor location.

The preferred embodiment of the method of associating products and sensors described above is depicted by the flowchart of FIGS. 9 and 10. Beginning with the first step 801 where a user logs in to the website and registers a planogram 802, list of users 803, desired reports 804 and alerts, and down loads an APP to a smart devices 805. Software algorithm decides how the user desires to place or present the items or products on the display incorporated into the system of the present invention. In the following step 901, the desired layout can be uploaded in a variety of manners including but not limited to (a) manually entering the layout information for each product and sensor into the database application, (b) uploading a layout data-file such as a planogram, and (c) entering the layout information by electronically scanning a barcode associated with a particular area on the layout.

FIG. 10 depicts the preferred embodiment of the process of taking a sensor reading by the controller is as follows. Beginning with the display hook system in its “SLEEP” state 1000, an item is added or removed from the display hook. This movement causes a vibration sensor to transition 1001 the display hook to its “WAKE” state 1002. In the “WAKE” state the microcontroller in the display hook polls the proximity sensor at pre-determined intervals and transmits these readings to the controller. After a pre-determined time of no product movement the display hook transitions back to the “SLEEP” state steps 1003-1008

### Advantages and Uses

The benefits and advantages of the present invention are many as it can be used in a variety of settings and circumstances. For example, the apparatus may be employed to alert law enforcement about the occurrence of thefts or pilferage in real time via a convenient and un-intrusive mobile application. Through a computer device configured to receive information from the database, law enforcement personnel would be capable of observing a visual indication of a potential criminal occurrence. In the retail context, the apparatus can serve to provide reports of the levels of stock of various items to enable authorized users to determine potential trending activities concerning particular areas or items. This present invention may be especially advantageous to detect patterns of activities that can be linked to theft or similar crime and can facilitate the expedient apprehension of shoplifters.

Other advantages of the present invention include the ability to provide automatic updates to third parties such as direct store delivery companies to notify such entities that the inventory of their products is running low or that the products are out of stock. In a similar manner, the invention can provide consolidated reports concerning the status of product or item inventory to the leadership, security, and merchandise personnel of the enterprise employing the apparatus.

Additional practical benefits and advantages of the present system include the absence of moving parts susceptible to deterioration due to use and wear-and-tear, thereby making the system more durable and long-lasting than it would have otherwise been. This also entails the reduced need for repair and ensures a low cost of repair and maintenance of the system.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may have been omitted so as to not unnecessarily obscure the embodiments.

While multiple examples are disclosed, still other examples of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An inventory tracking apparatus comprising: A method and system of detecting an item or product's movement and location on a display comprising the steps of: a) placing a sensing device on a display apparatus; b) creating and detecting at least one unique sensor signal change created by the movement of products on the display apparatus through interaction of the item with a sensor c) associating said unique sensor signal in a data base to a product or item on the display indicating the product information and its location on both the display hook and the display; d) translating said sensor signal into an alert sent to a smart device through a wireless network; e) recording and storing item movement and location in a database f) retrieving the movement and location information by means of a smart device.

2. The method of generating a unique sensor signal from a display apparatus as described in claim 1, wherein said sensor signal is generated by detected changes in distance of the item or product by means of an encoded card placed on or near the display apparatus sensing device.

3. The method of analyzing said sensor signal as described in claim 2 by use of a software algorithm.

4. The method of recording said sensor signal as described in claim 3 as stored information in a database.

5. The method of retrieving said stored information about said sensor signal described in claim 4, further comprising the step of indexing and associating the store information to a particular location.

6. The method of alerting the movement of or on said display apparatus described in claim 1 by means of an accelerometer.

7. The method of downward inclining of said display apparatus at an angle of 8 degrees +/− to allow for the items to move away from the sensor by means of gravitational forces or other mechanical device such as a spring when an item is removed from the display apparatus.

8. The method of arranging and deploying uniquely encoded cards on a display apparatus to determine the distance and movement from a display.

9. The method of arranging patterns on display apparatus cards corresponding to unique characteristics for the appropriate for the type of item to be detected.

10. A method of deploying a microcontroller to cycle through the various display apparatuses and record said sensor signal readings and upload these readings to a software application that correlates the readings with individual items through a network.
